(19) United States
(12) Patent Application Publication
(10) Pub. No.: US 2008/0137366 A1
(43) Pub. Date: Jun. 12, 2008

(54) LIGHT GUIDE PLATE AND BACKLIGHT MODULE INCLUDING THE SAME

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/831,967

(22) Filed: Aug. 1, 2007

(30) Foreign Application Priority Data
Dec. 7, 2006 (CN) 200610201231.4

(51) Int. Cl. F21V 8/00

(52) U.S. Cl. 362/607; 362/617

(57) ABSTRACT

An exemplary light guide plate includes a base plate having a bottom surface, an emitting surface opposite to the bottom surface, and a plurality of side surfaces being perpendicular to and connected between the emitting surface and the bottom surface. A reflecting film with an opening covers the side surfaces of the light guide plate, and faces a light source to enable light beams from the light source enter the light guide plate. The light guide plate with the reflecting film increases efficiency in the utilization of light beams. A backlight module including the light guide plate is also disclosed.

### BACKGROUND OF THE INVENTION

1. Field of the Invention

The present invention relates to a backlight module, and particularly to a backlight module with a light guide plate having high efficiency in the utilization of light beams.

2. Description of Related Art

A liquid crystal display is capable of displaying a clear and sharp image with millions of pixels elements. It has thus been applied to various devices in which a message or picture needs to be displayed, such as mobile phones and notebook computers. However, liquid crystal in the liquid crystal display does not itself emit light. Instead, the liquid crystal has to be lit up by a light source so as to clearly and sharply display text and images.

A conventional backlight module is represented in FIG. 4. The backlight module generally includes a housing 700 accommodating a light source 100, a reflector 200, a light guide plate 300, a diffusion plate 400, a lower brightness enhancement film 500, and an upper brightness enhancement film 600. The light source 100 can be a linear light source or a point light source. The light guide plate 300 is configured for receiving light beams from the light source 100, and for evenly distributing the light beams over the entire light guide plate 300 through reflection and diffusion. The reflector 200 is disposed under the light guide plate 300 for upwardly reflecting light beams from the light source 100 to the light guide plate 300. The diffusion plate 400, the lower brightness enhancement film 500, and the upper brightness enhancement film 600 are disposed on the light guide plate 300 sequentially to increase a diffusion efficiency of the light transmitted from the light guide plate 300.

In operation, light beams emitted from the light source 100 enter the light guide plate 300. Some of the light beams strike a bottom surface of the light guide plate 300, are reflected by the reflector 200, and then exit through a top surface of the light guide plate 300. Other light beams directly exit through the top surface of the light guide plate 300. The light beams that exit through the top surface then transmit through the diffusion plate 400, the lower brightness enhancement film 500, and the upper brightness enhancement film 600, and finally illuminate a liquid crystal panel (not shown).

However, some of light beams propagating within the light guide plate 300 strike the side surfaces thereof. Light beams striking the side surfaces of the light guide plate 300 are liable to leak out from the side surfaces and be lost. Thereby, the backlight module may have low efficiency in the utilization of light beams.

What is needed, therefore, is a backlight module which can provide highly efficient utilization of light beams.

### SUMMARY OF THE INVENTION

An exemplary light guide plate includes a base plate having a bottom surface, an emitting surface opposite to the bottom surface, and a plurality of side surfaces being perpendicular to and connected between the emitting surface and the bottom surface. A reflecting film with an opening covers the side surfaces of the light guide plate, and faces a light source to enable light beams from the light source enter the light guide plate. The light guide plate with the reflecting film increases efficiency in the utilization of light beams.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic side view of a backlight module in accordance with a preferred embodiment of the present invention;

FIG. 2 is a top plan view of a light guide plate of FIG. 2 together with a plurality of point light sources;

FIG. 3 is a top plan view of a light guide plate of FIG. 2 together with a linear light source; and

FIG. 4 is a schematic side view of a conventional backlight module;

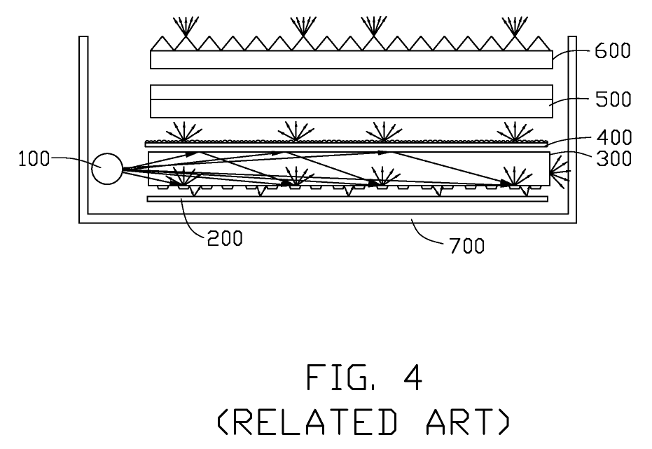

### DETAILED DESCRIPTION OF THE INVENTION

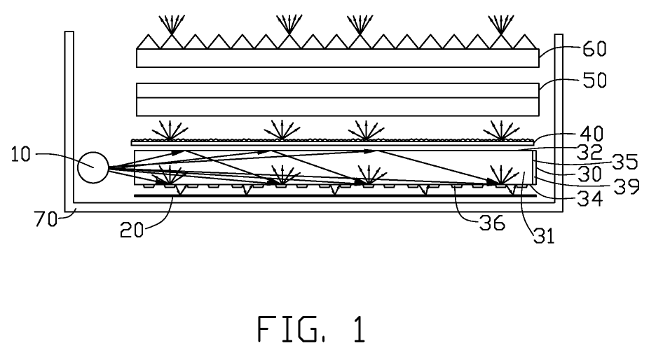

Referring to FIG. 1, a backlight module in accordance with an embodiment of the present invention includes a housing 70 accommodating a light source 10, a reflector 20, a transparent light guide plate 30, a diffusion plate 40, a lower brightness enhancement film 50, and an upper brightness enhancement film 60 therein.

The light source 10 can be a linear light source or a point light source. The light source 10 is located adjacent to the light guide plate 30. The light guide plate 30 comprises a base plate 31, and the base plate 31 comprises a bottom surface 34 on which a plurality of preferably round identical protrusions 36 are formed, an emitting surface 32 opposite to the bottom surface 34, and four side surfaces 35 perpendicularly connected between the emitting surface 32 and the bottom surface 34. The protrusions 36 diffuse light beams coming from the light source 10, so that light beams are evenly emitted from the emitting surface 32. The light guide plate 30 is made of acrylic material to provide a uniformly reflecting surface for guiding light. The light guide plate 30 is configured for receiving light beams from the light source 10, and for evenly distributing the light beams over the entire light guide plate 30 through reflection and diffusion. The reflector 20 is disposed under the light guide plate 30 for upwardly reflecting light beams from the light source 10 to the light guide plate 30. The diffusion plate 40, the lower brightness enhancement film 50, and the upper brightness enhancement film 60 are disposed on the light guide plate 30 sequentially to increase a diffusion efficiency of the light transmitted from the light guide plate 30.

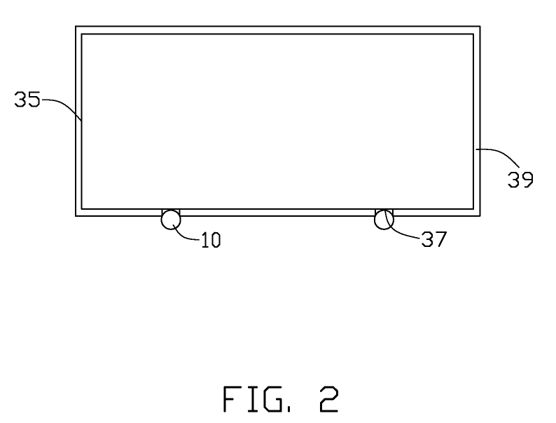

Referring to FIG. 2, when the light source 10 is a plurality of point light sources, a reflecting film 39 with openings 37 covers the four side surfaces 35 of the light guide plate 30, and the openings 37 are defined corresponding to the point light sources to enable light beams of the point light sources to enter the light guide plate 30. The reflecting film 39 is made of silver or aluminum material that have good light reflecting characteristics, and the reflecting film 39 reflects any light beams that leak out from the side surfaces 35 into the light guide plate 30 to increase efficiency in the utilization of light beams.

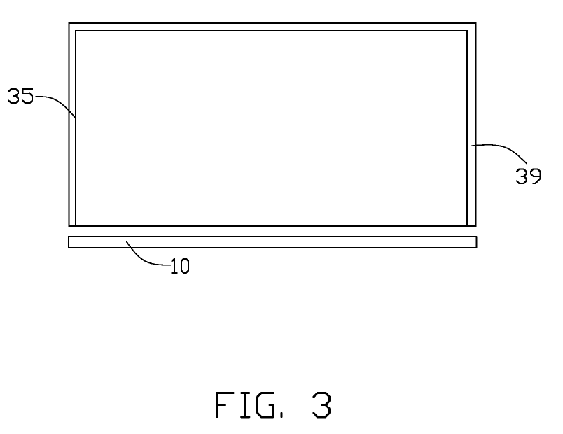

Referring to FIG. 3, when the light source 10 is a linear light source, one of the side surfaces 35 facing the light source 10 acts as a light incident surface, and receives light beams from the light source 10. A reflecting film 39 is attached to the side surfaces 35 of the light guide plate 30 except the light incidence surface. The reflecting film 39 reflects light beams that leak out from the side surfaces 35 into the light guide plate 30 to increase efficiency in the utilization of light beams.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate configured for guiding light beams from a light source in order to uniformly illuminate a liquid crystal panel, comprising:
a transparent base plate having a bottom surface, an emitting surface opposite to the bottom surface, and a plurality of side surfaces being perpendicular to and connected between the emitting surface and the bottom surface, and
a reflecting film covering the side surfaces of the base plate, the reflecting film defining at least one opening therein, wherein the opening faces the light source to enable light beams from the light source to enter the light guide plate, the reflecting film reflects light beams that leak out from the side surfaces into the base plate.

2. The light guide plate as claimed in claim 1, wherein a plurality of protrusions is formed on the bottom surface of the light guide plate.

3. The light guide plate as claimed in claim 1, wherein the reflecting film is made of silver or aluminum material.

4. The light guide plate as claimed in claim 1, wherein the base plate is made of acrylic material.

5. A backlight module, comprising;
a light guide plate comprising a base plate having a bottom surface, an emitting surface opposite to the bottom surface, a plurality of side surfaces connecting the emitting surface with the bottom surface, and a reflecting film with an opening covering the side surfaces of the light guide plate;
a light source arranged facing the opening, light beams from the light source entering the light guide plate through the opening; and
a housing arranged for accommodating the light guide plate and the light source therein.

6. The backlight module as claimed in claim 5, wherein a plurality of protrusions is formed on the bottom surface of the light guide plate.

7. The backlight module as claimed in claim 5, wherein the reflecting film is made of silver or aluminum material.

8. The backlight module as claimed in claim 5, wherein the base plate is made of acrylic material.

9. The backlight module as claimed in claim 5, further comprising a diffusion plate, a lower brightness enhancement film, and an upper brightness enhancement film disposed on the light guide plate sequentially.

10. The backlight module as claimed in claim 5, wherein a reflector is disposed under the light guide plate and accommodated in the housing.

11. The backlight module as claimed in claim 5, wherein the light source is a point light source received in the opening.

12. The backlight module as claimed in claim 5, wherein the light source is a linear light source, and the opening has a shape fitting with the linear light source.
